(19) United States
(12) Patent Application Publication
(10) Pub. No.: US 2007/0235891 A1
(43) Pub. Date: Oct. 11, 2007

(54) Method of making artificial stone

(76) Inventor: Ching-Liang Chu, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 11/411,089

(22) Filed: Apr. 26, 2006

(30) Foreign Application Priority Data
Apr. 5, 2006 (CN) 200610066717.1

(51) Int. Cl. B29C 41/22; B29C 41/50

(52) U.S. Cl. 264/71; 264/255

(57) ABSTRACT

A method of making an artificial stone includes the steps of mixing a flexible resin and a rigid resin. Adding aluminum hydroxide in the mixed resin and stirring to form a fluid base material. Adding powder in the fluid base material and stirring to form a fluffy first pattern material and a second pattern material respectively. Pouring the fluid base material in a mold to form a base member. Spraying the first pattern material and the second pattern material on the base member to form a texture layer thereon. Removing air bubbles, and solidifying the base member and the texture layer to form the artificial stone. The artificial stone made by the method of present invention has the pattern has varied aspects and gradations.

### BACKGROUND OF THE INVENTION

1. Field of the Invention

The present invention relates generally to a artificial stone, and more particular to a method of making an artificial stone with varied texture.

2. Description of the Related Art

In modem life, an architectural stone, which is a semi-transparent stone with varied texture, is provided to build ceiling, lampshade, decorative wall or column, or basin. Because there is fewer and fewer natural stone for use and the regular size (about 40 cm×60 cm) of a single stone is very heavy, there are more and more architectural stones replacing nature stones. FIG. 1 shows the flow chart of making the conventional architectural stone 10 including the steps of 21, 22 and 23. The 21 step is mixing and stirring powder and single resin to have a fluid molding material 11. The 22 step is pouring the molding material 11 to a mold 12. The 23 step is waiting the molding material 11 solidified to form the architectural stone 10, and then take the architectural stone 10 out.

Above method still has a few drawbacks, which includes:

1. There only are resin with single property, including flexible resin (lower reactive and riot-complete harden resin) and rigid resin (higher reactive and complete harden resin). If the molding material 11 is mixed by powder and flexible resin, the architectural stone 10 is flexible and limited in size. If the molding material 11 is mixed by powder and rigid resin, the architectural stone 10 may be broken by impact.

2. The architectural stone 10 usually has a regular texture because the molding material 11 is mixed by powder and single property resin.

### SUMMARY OF THE INVENTION

The primary objective of the present invention is to provide a method of making an artificial stone, which the stone has the characters of harder, not easy break, without limitation of size, and with varied texture.

According to the objective of the present invention, a method of making an artificial stone comprises the steps of:

(A) Mixing a flexible resin and a rigid resin with a weight ratio of 20%˜80%:80%˜20% to have a mixed resin.

(B) Adding 5%˜70% of aluminum hydroxide in the mixed resin and stirring to form a fluid base material.

(C) Adding powder in the fluid base material and stirring to form a fluffy first pattern material, wherein a weight ratio of the fluid base material and the powder is 1:3˜1:4.5, and powder includes aluminum hydroxide and calcium carbonate with a weight ratio of 99%˜95%:1%˜5%.

(D) Adding powder in the fluid base material and stirring to form a fluffy second pattern material, wherein a weight ratio of the fluid base material and the powder is 1:3˜1:4.5, and powder includes aluminum hydroxide and calcium carbonate with a weight ratio of 60%˜90%:40%˜10%.

(E) Pouring the fluid base material in a mold to form a base member with a thickness of 1 mm˜5 mm.

(F) Spraying the first pattern material and the second pattern material on the base member to form a texture layer on the base member.

(G) Removing air bubbles from the base member and the texture layer.

(H) Solidifying the base member and the texture layer to form the artificial stone, and then taking the artificial stone out of the mold.

The artificial stone made by the method of present invention has both properties of flexible resin and rigid resin, and the stone is hard to be deformed and damaged and without limitation of size. The spraying first pattern material and the second pattern material make the artificial stone with varied aspects and gradations.

### BRIEF DESCRIPTION OF THE DRAWINGS

FIG. 1 is a flow chart of the conventional method of making the artificial stone;

FIG. 2 is a perspective view, showing the step of the conventional method of pouring the molding material in the mold;

FIG. 3 is an perspective view of the artificial stone made by the conventional method;

FIG. 4 is a flow chart of a preferred embodiment of the present invention;

FIG. 5, FIG. 6 and FIG. 7 shows how to prepare the first pattern material;

FIG. 8 is a perspective view of pouring the fluid base material in the mold to form the base member;

FIG. 9 is a perspective view of spraying the first pattern material on the base member; and

FIG. 10 is a perspective view of the artificial stone made by the method of present invention.

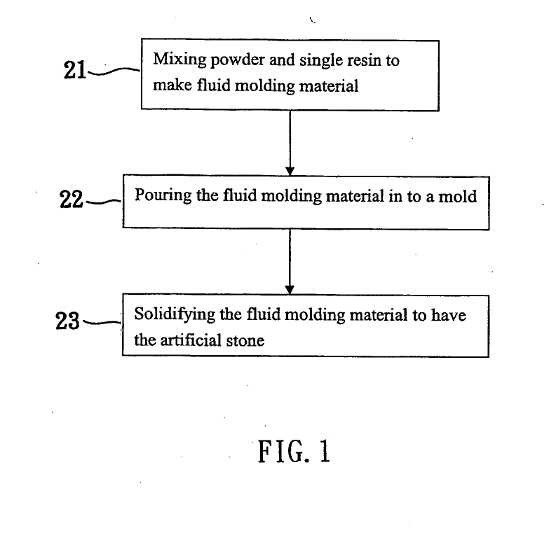

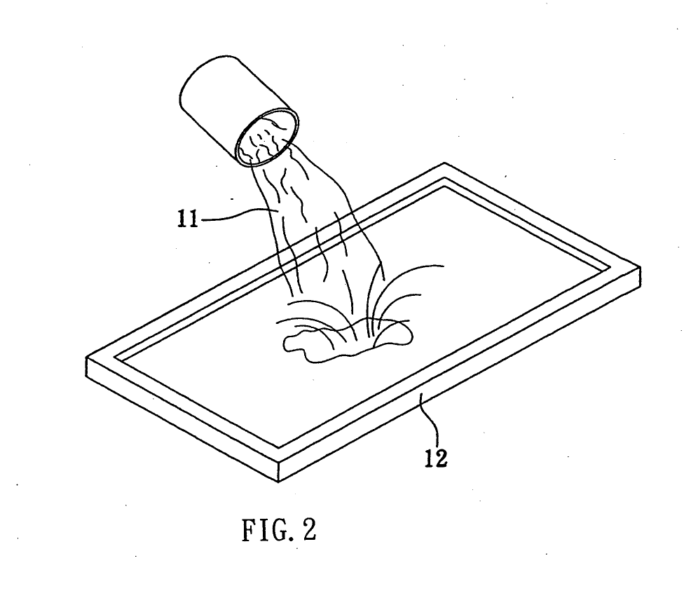

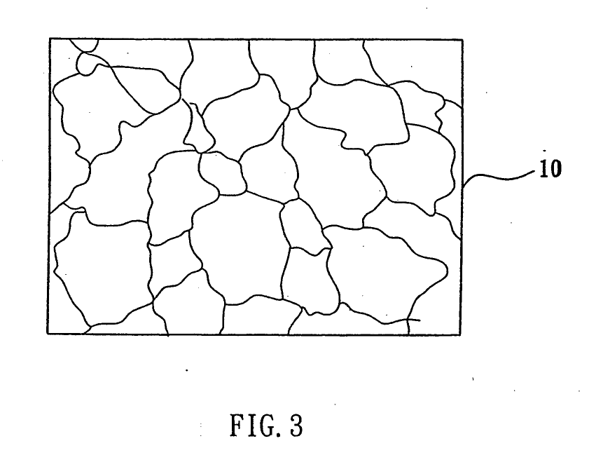

### DETAILED DESCRIPTION OF THE INVENTION

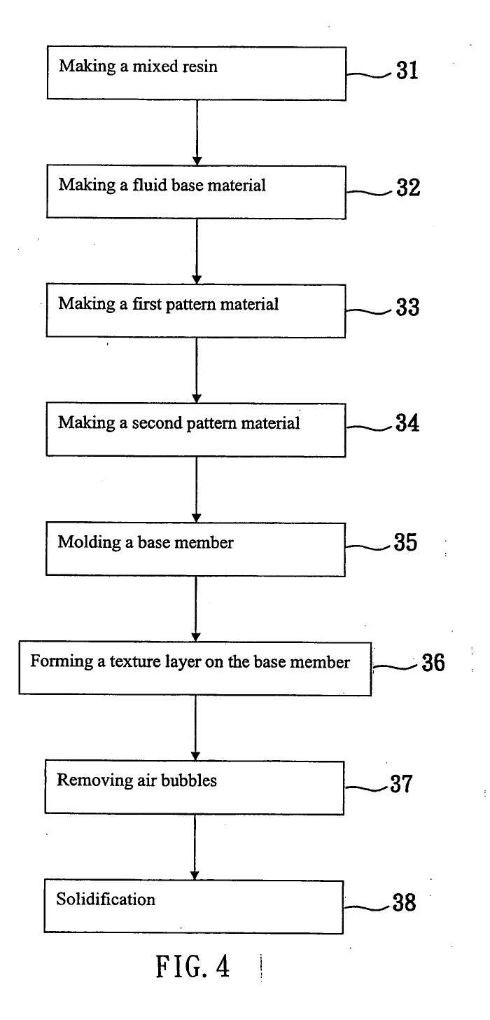

As shown in FIG. 4 to FIG. 7, a method of making an artificial stone of the present invention including the steps 31 to 37.

In the step 31, mixing a flexible resin and a rigid resin in a weight ratio of 20%˜80%:80%˜20% to have a mixed resin. The mixed resin has both properties of flexible resin and rigid resin.

In the present invention, the flexible resin may be MF-10 resin, which includes 30% of Maleic Anhydride, 15% of Propylene Glycol, 15% of Ethylene Glycol, 10% of Diethylene Glycol, and 30% of Styrene Monomer. The rigid resine may be MF-453M resin, which includes 25% of Maleic Anhydride, 25% of Isophthalic Acid, 15% of Propylene Glycol, 15% of Ethylene Glycol, and 30% of Styrene Monomer.

In the step 32, adding 5%˜70% of aluminum hydroxide into the mixed resin and stirring it to form a fluid base material 40. The aluminum hydroxide is the key material to make the artificial stone transparent. In the present invention, the average diameter of the aluminum hydroxide is 8.00 μm˜30.00 μm. A weight ratio of the mixed resin and the aluminum hydroxide is 1:0.5˜1:1.5. A viscosity of the fluid base material 40 is 15 PS˜22 PS. The speed of stirring is 50 rpm ˜80 rpm.

In the step 33, adding powder 50 in the fluid base material 40 and stirring it from bottom to top to form a first pattern material 60. A weight ratio of the fluid base material 40 and the powder 50 is 1:3˜1:4.5. The powder 50 includes aluminum hydroxide and calcium carbonate with a weight ratio of 99%˜95%:1%˜5%. In the present invention the powder 50 in the fluid base material 40 are stirred by hands from bottom to top to mix the powder 50 with the fluid base material 40 to form the fluffy, snowflake-like first pattern material 60. A density of the first pattern material 60 is 0.131 kg/cm³.

It is noted that the stirring machine may be used to stir the fluid base material 40 and the powder 50 to get the first pattern material 60. But, it may provide a regular texture on the artificial stone.

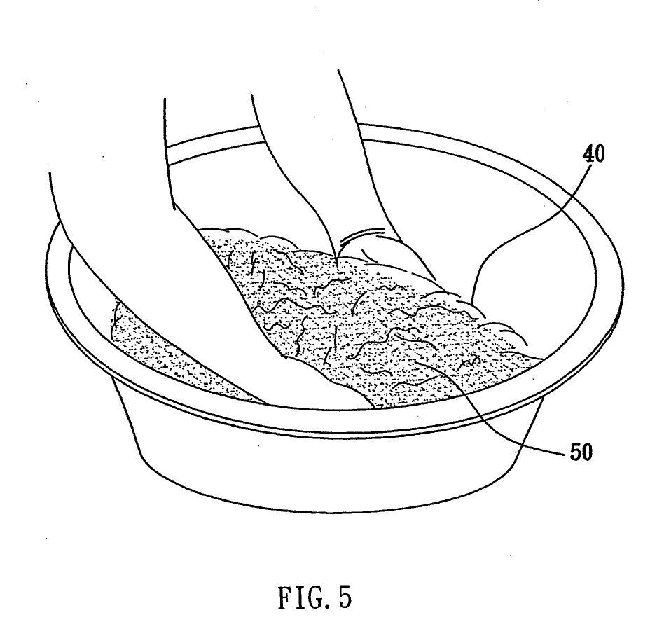

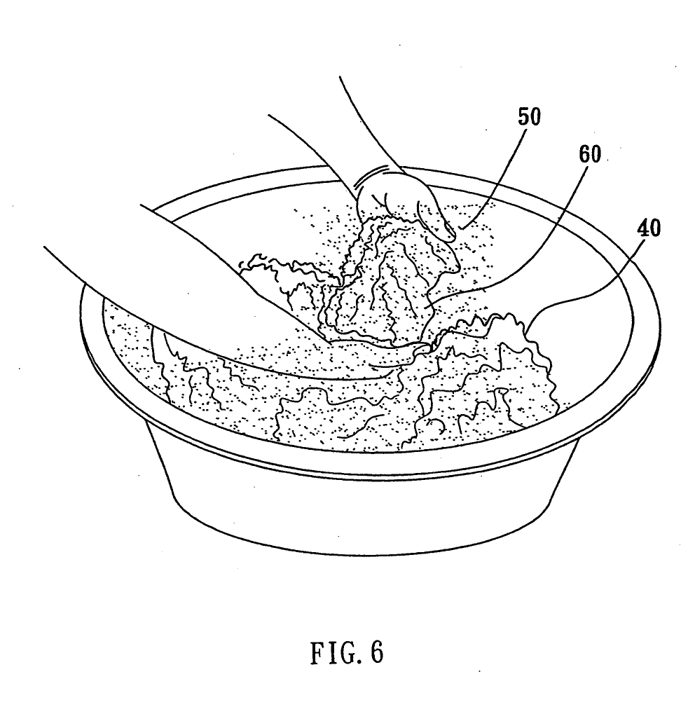

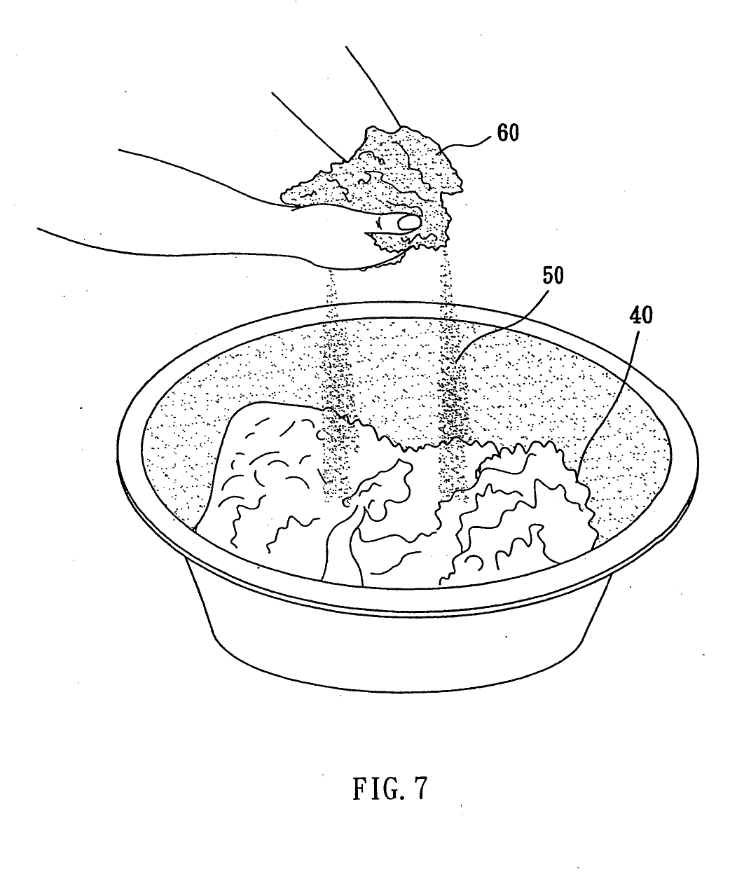

In the step 34, repeating the step 33, as shown in FIGS. 5 to 7, adding powder (not shown) in the fluid base material 40 and stirring it from bottom to top to form a second pattern material (not shown). A weight ratio of the fluid base material 40 and the powder is 1:3˜1:4.5. The powder 50 includes aluminum hydroxide and calcium carbonate with a weight ratio of 60%˜90%:40%˜10%. A weight ratio of the first pattern material 60 and the second pattern material is 1:0.8˜1:1.2.

The first pattern material 60 and the second pattern material may have different transparencies according to the weight ratio of aluminum hydroxide and calcium carbonate.

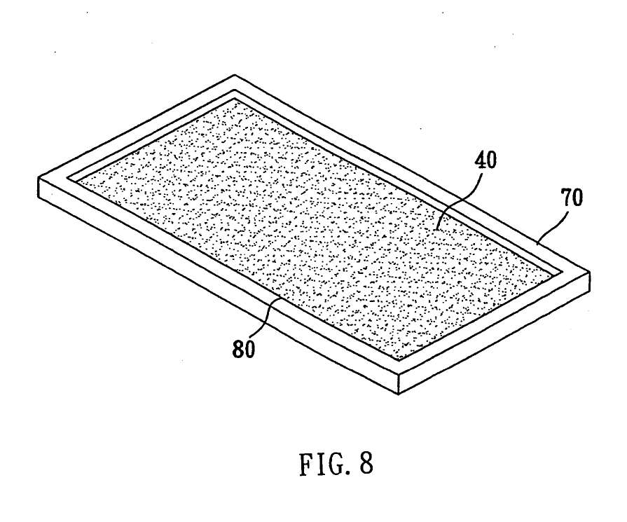

In the step 35, as shown in FIG. 8, pouring the fluid base material 40 in a mold 70 to form a base member 80. A thickness of the base member 80 is 1 mm˜5 mm.

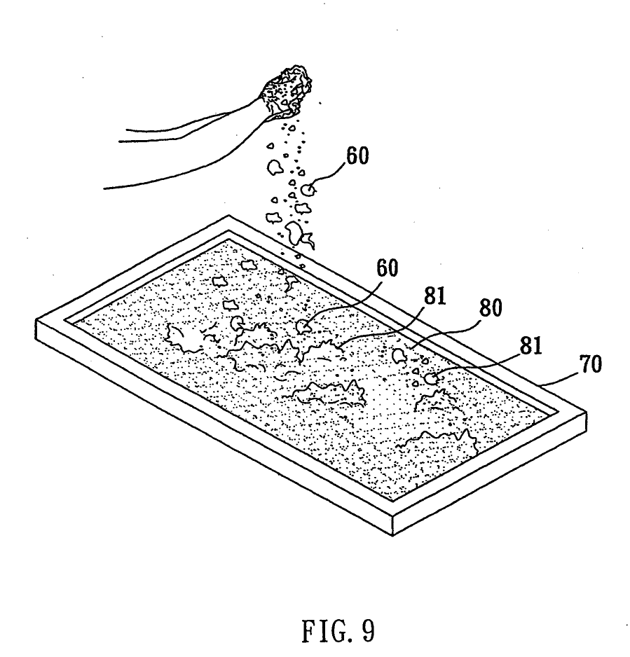

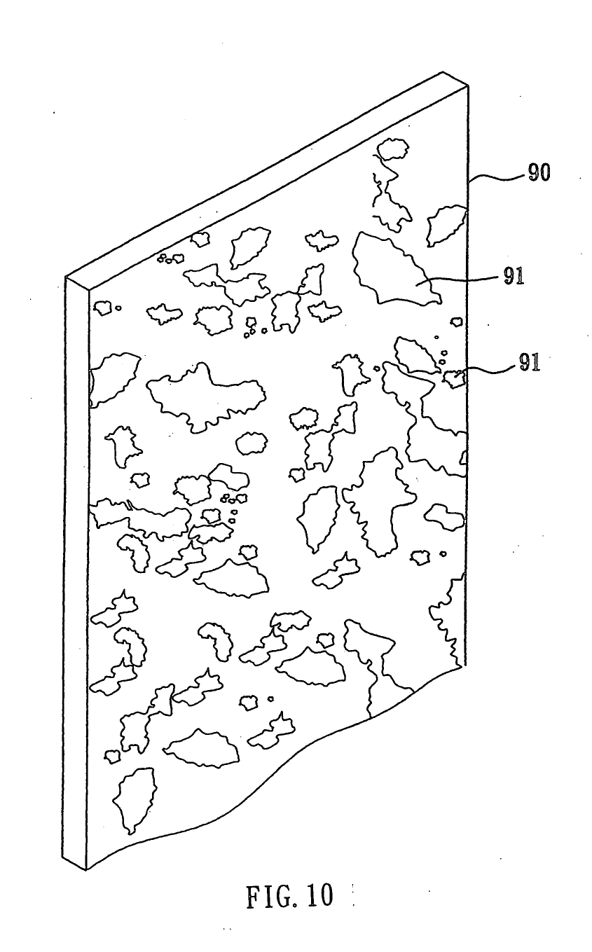

The step 36, as shown in FIG. 9 and FIG. 10, is spraying the first pattern material 60 and the second pattern material on the base member 80. The first pattern material 60 and the second pattern material are distributed on the base member 80 randomly to form a varied texture layer 81.

In the present invention, the height of spraying the first pattern material 60 and the second pattern material is 10 cm˜150 cm from the mold 70 that provides better distribution of the first pattern material 60 and the second pattern material. The diameters of the first pattern material 60 and the second pattern material sprayed on the base member are 3 mm˜50 mm.

It is noted that the work of spraying the first pattern material 60 and the second pattern material is made by labor. It also may be made by shovel or injection.

The step 37 is removing air bubbles in the base member 80 and the texture layer 81 to increase the product quality. This step may be done by vibrating the mold 70, or by impacting the mold 70, or by compressing.

The step 38 is waiting the base member 80 and the texture layer 81 for solidification to form an artificial stone 90, and then taking the artificial stone 90 out of the mold 70. The time of solidification is about two hours.

When the artificial stone 90 of the present invention is exposed under a light, it may be seen transparent and some pattern 91 with varied aspects and gradations.

Another preferred embodiment of the present invention, which is similar to the above embodiment, except that only the first pattern material 60 is sprayed on the base member 80. In other words, this method of making the artificial stone has all of the steps above but the step 34.

In conclusion, the advantages and characters of the present invention are listed hereunder:

1. The mixed resin of the present invention has both of the flexible resin and rigid resin to provides both characters of flexible and rigid that the artificial stone 90 made by the method of present invention has well properties of flexibility and rigidity that the artificial stone 90 is hard to be deformed and damaged, furthermore, the artificial stone 90 made by the method of present invention has no limitation of size.

2. The present invention includes the steps of fluffing the first pattern material 60 and the second pattern material and spraying the first pattern material 60 and the second pattern material on the base member 80 that the artificial stone 90 made by the method of present invention has the pattern 91 with varied aspects and gradations.

The description above only includes few preferred embodiments and the equivalence of the present invention is still in the scope of the claim of the present invention.

What is claimed is:

1. A method of making an artificial stone, comprising the steps of:
mixing a flexible resin and a rigid resin with a weight ratio of 20%˜80% 80%˜20% to have a mixed resin;
adding 5%˜70% of aluminum hydroxide in the mixed resin and stirring to form a fluid base material;
adding powder in the fluid base material and stirring to form a fluffy first pattern material, wherein a weight ratio of the fluid base material and the powder is 1:3˜1:4.5, and powder includes aluminum hydroxide and calcium carbonate with a weight ratio of 99%˜95%:1%˜5%;
adding powder in the fluid base material and stirring to form a fluffy second pattern material, wherein a weight ratio of the fluid base material and the powder is 1:3˜1:4.5, and powder includes aluminum hydroxide and calcium carbonate with a weight ratio of 60%˜90%:40%˜10%;
pouring the fluid base material in a mold to form a base member with a thickness of 1 mm˜5 mm;
spraying the first pattern material and the second pattern material on the base member to form a texture layer on the base member;
removing air bubbles from the base member and the texture layer;
solidifying the base member and the texture layer to form the artificial stone, and then taking the artificial stone out of the mold.

2. The method as defined in claim 1, wherein a weight ratio of the first pattern material and the second pattern material is 1:0.8˜1:1.2.

3. The method as defined in claim 1, wherein an average diameter of the aluminum hydroxide is 8.00 μm ˜30.00 μm, and a weight ratio of the mixed resin and the aluminum hydroxide is 1:0.5˜1:1.5 and a viscosity thereof is 15 PS˜22 PS.

4. The method as defined in claim 1, wherein the step of stirring powder in the fluid base material is done by labor in a way of stirring from bottom to top.

5. The method as defined in claim 1, wherein a height of spraying first pattern material and the second pattern material is 10 cm ˜150 cm from the mold.

6. The method as defined in claim 1, wherein diameters of the first pattern material and the second pattern material sprayed on the base member 3 mm˜50 mm.

7. The method 1 as defined in claim 5, wherein an diameter of the first pattern material and the second pattern material is 3 mm˜50 mm.

8. The method as defined in claim 1, wherein the step of removing the air bubbles from the base member and the texture layer is done by vibrating the mold.

9. The method as defined in claim 1, wherein the step of removing the air bubbles from the base member and the texture layer is done by impacting the mold by hand.

10. The method as defined in claim 1, wherein the step of removing the air bubbles from the base member and the texture layer is done by compressing the mold.

11. A method of making an artificial stone, comprising the steps of:
mixing a flexible resin and a rigid resin with a weight ratio of 20%˜80% 80%˜20% to have a mixed resin;
adding 5%˜70% of aluminum hydroxide in the mixed resin and stirring to form a fluid base material;
adding powder in the fluid base material and stirring to form a fluffy first pattern material, wherein a weight ratio of the fluid base material and the powder is 1:3˜1:4.5, and powder includes aluminum hydroxide and calcium carbonate with a weight ratio of 99%˜95%:1%˜5%;
pouring the fluid base material in a mold to form a base member with a thickness of 1 mm˜5 mm;
spraying the first pattern material on the base member to form a texture layer on the base member;
removing air bubbles from the base member and the texture layer;
solidifying the base member and the texture layer to form the artificial stone, and then taking the artificial stone out of the mold.

12. The method as defined in claim 11, wherein a weight ratio of the first pattern material and the second pattern material is 1:0.8˜1:1.2.

13. The method as defined in claim 11, wherein the step of stirring powder in the fluid base material is done by labor in a way of stirring from bottom to top.

14. The method as defined in claim 11, wherein a height of spraying first pattern material and the second pattern material is 10 cm ˜150 cm from the mold.

15. The method as defined in claim 11, wherein diameters of the first pattern material and the second pattern material sprayed on the base member 3 mm˜50 mm.

16. The method as defined in claim 14, wherein an diameter of the first pattern material and the second pattern material is 3 mm˜50 mm.

17. The method as defined in claim 11, wherein the step of removing the air bubbles from the base member and the texture layer is done by vibrating the mold.

18. The method as defined in claim 11, wherein the step of removing the air bubbles from the base member and the texture layer is done by impacting the mold by hand.

19. The method as defined in claim 11, wherein the step of removing the air bubbles from the base member and the texture layer is done by compressing the mold.
